(19) United States
(12) Patent Application Publication
(10) Pub. No.: US 2026/0054736 A1
(43) Pub. Date: Feb. 26, 2026

(54) INTEGRATED CLOSED-COURSE DRIVING SYSTEMS AND METHODS FOR ADAPTIVE ON-TRACK DRIVER PERFORMANCE OPTIMIZATION

(71) Applicant: Brittnee L. Dier, Novi, MI (US)

(72) Inventor: Brittnee L. Dier, Novi, MI (US)

(21) Appl. No.: 19/209,034

(22) Filed: May 15, 2025

Related U.S. Application Data
(60) Provisional application No. 63/685,337, filed on Aug. 21, 2024.

(51) Int. Cl. B60W 40/09; B60K 35/23; B60K 35/28; B60W 40/06

(52) U.S. Cl. CPC B60W 40/09; B60K 35/23; B60K 35/28; B60W 40/06

(57) ABSTRACT

Presented are smart driver feedback systems and control logic for adaptive on-track driver performance optimization, methods for making/using such systems, and closed-course racetracks equipped with such systems. A driver feedback system for a driver of a motor vehicle includes a system memory device that stores system data, and a data communication interface that is connected to the system memory device and a network of sensing devices on a closed-course racetrack. The driver feedback system also includes an interactive touchscreen display interface and a system controller. The system controller initializes system operation and collects data from the networked sensing devices on the closed-course racetrack. Collected data is stored on the system memory device and analyzed using a system iteration and learning module. The system controller generates a set of individualized feedback instructions specific to the driver and commands the touchscreen display interface to display the individualized feedback instructions to the driver.

### CLAIM OF PRIORITY AND CROSS-REFERENCE TO RELATED APPLICATION

This application claims the benefit of and priority to U.S. Provisional Ser. No. 63/685,337 , which was filed on Aug. 21, 2024, and is incorporated herein by reference in its entirety and for all purposes.

### TECHNICAL FIELD

The present disclosure relates generally to driving systems and control logic for evaluating driver performance. More specifically, aspects of this disclosure relate to sensor-based networked racetrack feedback systems for on-track driver coaching.

### INTRODUCTION

Automobile racing began over a century ago with the first organized race contest taking place in France in the late 19^{th} Century. With its continual rise in popularity and ever-increasing prize money, professional and amateur racecar drivers are persistently attempting to improve their driving skills, including cornering, tracking, shifting, etc., to shave seconds or even fractions of seconds off their lap times. Traditional approaches to driver training typically entail thousands of hours—with attendant costs and maintenance—devoted to on-track practices and instructor training. In addition to the exorbitant costs and time consumption, such approaches are not necessarily effective nor do they meet the different needs of individual drivers. For instance, many drivers may prefer real-time empirical analysis and feedback of their driving performance without the cost and time-restrictions associated with in-person instruction.

### SUMMARY

Presented below are closed-course driver feedback systems with attendant control logic for adaptive on-track driver performance optimization, methods for manufacturing and methods for operating such driver performance optimization systems, and closed-course racetracks equipped with such systems. By way of non-limiting example, an integrated and networked smart driver feedback system provisions individualized on-track performance evaluation and feedback through data collection hardware and analysis. An Adaptive Driving Information System (ADIS) may act as a comprehensive driver training and performance optimization platform, which employs integrated hardware and software components to collect, analyze, and derive driver-specific feedback based on track data, driver data, and vehicle data. ADIS may employ a combination of advanced vehicle and physiological telemetry devices, biometric sensors, in-vehicle information hardware, and a user-friendly and interactive graphical user interface (GUI) that delivers real-time feedback, personalized coaching, and performance recommendations.

The ADIS architecture may be an integrated, modular platform designed to deliver personalized, context-aware performance coaching for drivers on closed-course racetracks. By aggregating data from multiple modalities—including driver, vehicle, environmental, track, etc.—ADIS may construct a comprehensive set of session context conditions. The system employs supervised machine learning algorithms, such as gradient-boosted trees, decision trees, or similar models, to analyze multi-network session data and generate individualized coaching feedback. This feedback is dynamically aligned with driver-selected performance objectives and contextual metrics, enabling adaptive and goal-specific instruction throughout and after a driving session. Feedback may be prioritized based on safety and performance goals, and may be delivered through various interfaces, including real-time prompts and post-session reports. An Operator Management System (OMS) may allow track operators to define performance benchmarks and session parameters, ensuring that feedback is tailored to both driver needs and track-specific conditions.

Disclosed driver performance evaluation and coaching systems employ real-time data integration from multiple sources to provide individualized driver feedback. The ADIS architecture utilizes machine learning to analyze driver behavior in conjunction with vehicle dynamics and environmental conditions, delivering context-sensitive coaching to enhance driving performance and safety on racetracks. Conventional driver feedback systems, whether designed for motorsport telemetry, vehicle performance logging, or real-time coaching, primarily focus on collecting and displaying raw vehicle data, such as lap times, throttle input, and corner speeds. These systems are vehicle-centric constructs that lack contextual awareness and therefore provide limited or no personalization. Moreover, conventional systems typically operate using fixed “communal” benchmarks, rely on static environmental assumptions, and do not adapt feedback based on user skill level, evolving objectives, or dynamic track conditions. Existing systems also fail to integrate operator-defined standards or provide multi-role interfaces for track administrators and drivers.

The Adaptive Driver Information System may employ a multi-network integration architecture—synthesizing data from driver physiological telemetry, vehicle telemetry, track geometry, and environmental sensors—to derive a real-time context frame specific to a subject driver training session. ADIS may incorporate a dual-stakeholder model that serves both drivers and track operators through dedicated subsystems that influence but do not override one another. The system's Objective-Based Feedback Prioritization model ensures that coaching is both personalized and aligned with a driver's declared goals, rather than providing only a generic or exhaustive telemetry interpretation. Unlike existing systems, ADIS may incorporate a Curriculum-Aligned Skill Development Engine and a Reinforcement-Driven Personalization Loop that enable feedback that evolves based on session outcomes, learning progression, and user responses. By combining segment-level analysis with advanced algorithmic methods, including dynamic programming for optimal path calculation, predictive modeling for evolving benchmarks, and hybrid machine learning models with explainable outputs, ADIS enables fine-grained skill decomposition and coaching feedback that adapts both over time and within the specific context of each driving session. In general, the ADIS architecture remediates critical gaps in existing driver-coaching frameworks by transforming isolated data sets into intelligent, objective-specific, and role-aware coaching experiences.

Professional driving schools may use ADIS to provide advanced, data-driven training to their students, offering a competitive edge over traditional methodologies. Amateur enthusiasts and other individuals who participate in track days and racing events may use ADIS to improve driving skills and performance through personalized feedback and coaching. Professional drivers and racing teams may utilize ADIS for continuous performance enhancement to ensure they maintain a competitive edge by leveraging detailed performance metrics and recommendations. Automobile manufacturers may integrate ADIS into high-performance vehicle platforms to offer operators a built-in, advanced driver training system. Race insurance companies may incorporate ADIS data to develop more accurate risk profiles and offer discounts for safe driving practices, incentivizing the adoption of the system.

Traditionally, personalized feedback and coaching in motorsport driving are provided through one-on-one instruction, which can be expensive and logistically challenging. ADIS may help to solve this problem by using advanced algorithms to analyze track data, driver data, and vehicle data collected through various on-track and in-vehicle hardware devices. The ADIS platform may provide individualized recommendations for improving driver performance that can be tailored to specific objectives, such as lap time reduction, vehicle control, braking precision, or physiological targets including mental focus and stress reduction, as inferred from biometric telemetry. These features and options may make high-quality coaching more accessible and scalable, reducing reliance on private instructors and enabling drivers to receive constant, data-driven feedback.

On-track safety may be a critical concern for owners, operators, and insurers; ADIS may enhance safety by promoting and standardizing safe driving practices through an interactive, adaptable, and gamified platform. Drivers may be encouraged to compete against their own previously defined milestones and statistics rather than others, fostering a safer and more controlled driving environment. Additionally, the ADIS platform may recommend specific educational courses and hands-on exercises for skill mastery, e.g., via gamified instruction sessions and objectives, further contributing to driver safety. The integration of vehicle data may allow ADIS to suggest tailored vehicle upgrades and adjustments, ensuring that both the driver and the vehicle are optimized for peak performance and safety.

ADIS may aggregate and leverage personalized driver data to provide customized insights that are typically difficult and expensive to obtain. By continually collecting and analyzing data from an on-track network of devices, the vehicle, and the driver, ADIS may derive patterns and specific areas for improvement that might otherwise be missed by human instructors or track facilitators. This data-driven approach helps to ensure that drivers receive precise and actionable feedback, tailored to their unique driving style and performance metrics. High-quality driver training has historically been limited to those who can afford personal coaching or who have access to specialized training programs. ADIS democratizes driver training by providing a scalable, intuitive solution that may be adapted to just about any prospective driver. This makes advanced driving techniques and performance improvement accessible to a wider audience, potentially raising the overall skill level within the motorsport community.

ADIS may implement predefined gamification features to increase driver engagement and motivation. By enabling drivers to routinely track their progress, set personal goals, and compete against their and, if desired, other drivers'previous records, ADIS makes the learning process more enjoyable. This may lead to more consistent practice and faster skill development, as drivers are more likely to stay motivated and engaged over the long term. For owners of private motorsport driving circuits and racetracks, ADIS may also help to decrease operational costs by minimizing or eliminating human instructors and reducing insurance costs. By automating driver feedback and coaching processes, track owners are able to offer high-quality training without the need to hire additional staff. This can make their facilities more attractive to drivers, increasing usage and revenue.

Human instructors can vary in their teaching methods and effectiveness, leading to inconsistencies in driver training and feedback. ADIS is designed to provide consistent, objective feedback based on empirical data and, thus, helps to ensure that drivers receive a consistently high standard of coaching. This consistency may also help to maintain a uniform level of skill development across different drivers. In high-performance environments, the ability to make immediate adjustments can be crucial; ADIS may provide real-time feedback during driving sessions, allowing drivers to make on-the-fly adjustments to their technique. This immediate feedback loop may help to quickly correct mistakes and optimize driver performance during driving sessions.

In addition to the possible benefits described above, ADIS may help to revolutionize driver education and performance optimization by providing continuous, personalized feedback through advanced data analytics, reducing the need for private instructors, enhancing safety, and fostering a more engaging and enjoyable driving experience. The ADIS platform may leverage advanced sensing and data analytics technology to offer scalable, autonomous coaching, making high-level racing techniques and safety practices accessible to a broader range of drivers. ADIS may help to improve driver performance and safety while also enhancing the overall experience for track facility owners and users. It may offer a comprehensive solution that leverages data and technology to revolutionize high-performance driving training and management.

Aspects of this disclosure are directed to memory-stored system control protocols, system control logic, and non-transitory computer readable media (CRM) for provisioning adaptive on-track driver performance optimization. In an example, a method is presented for operating a driver feedback system for an operator of a motor vehicle, such as a professional or amateur driver of an automobile on a closed-course racetrack. This representative method includes, in any order and in any combination with any of the above and below disclosed options and features: initialize, e.g., via a resident or remote processors, control module, programmable logic device, central controller, or network of processors/controllers/modules/devices (collectively “controller” or “system controller”), operation of the driver feedback system; collect, e.g., in real-time via the system controller and/or integrated subsystems using a data communication interface, data from the network of sensing devices; store the collected data on a system storage device, such as a server-class database or cloud-computing storage service; analyze the collected data using a system iteration and learning module, such as a trained and supervised machine learning module; generate, e.g., via the system controller and/or integrated subsystems, a set of individualized feedback instructions specific to the driver; and command a graphical display, such as an interactive touchscreen display interface, to display the set of individualized feedback instructions to the driver, which may include user-selectable options to retrieve, view, modify, and/or export data and interactive features for utilizing the data and feedback instructions.

Additional aspects of this disclosure are directed integrated and networked smart driver feedback systems that provision individualized on-track performance evaluation and vehicle driver feedback through data collection hardware and analysis. As used herein, the terms “vehicle” and “motor vehicle” may be used interchangeably and synonymously to include any relevant vehicle platform, such as passenger vehicles, high-performance racecars, supercars, off-road and all-terrain vehicles (ATV), motorcycles, e-bikes, etc. In an example, a driver feedback system includes a system storage device that stores system data, and a data communication interface that is operatively connected to the system storage device and a network of sensing devices on a closed-course racetrack. The driver feedback system may also include an interactive touchscreen display interface, which may be integrated into a handheld, wireless-enabled personal computing device (PCD) or an in-vehicle centerstack telematics unit, and a system controller, which may be embodied as a central processing unit of a server-class back office (BO) computing terminal. The system controller is programmed to initialize operation of the driver feedback system and, once initialized, collect data from the network of sensing devices on the closed-course racetrack. The collected data is then stored on the system storage device and analyzed, e.g., using a system iteration and learning module. The system controller uses the analyzed data to generate a set of individualized feedback instructions specific to the driver. The interactive touchscreen display interface displays the individualized feedback instructions to the driver.

Aspects of this disclosure are also directed to methods of operating an integrated driver feedback system for a driver of a motor vehicle on a closed-course track. In this example, the method includes: retrieving, via a system controller of the integrated driver feedback system, a respective driver profile specific to the driver; determining, via the system controller using the driver profile, a respective set of baseline driving goals and driving session parameters specific to the driver; receiving, via the system controller from a system memory device, track topography data specific to the closed-course track; collecting, via the system controller from a network of vehicle sensors and driver sensors while the motor vehicle is driven on the closed-course track, sensor data indicative of real-time vehicle telemetry data of the motor vehicle and real-time driver physiological telemetry data of the driver; generating, via the system controller using a trained and supervised machine learning (ML) model, a set of individualized feedback instructions specific to the driver based on the set of baseline driving goals and driving session parameters specific to the driver, the track topography data, the real-time vehicle telemetry data, and the real-time driver physiological telemetry data; and commanding, via the system controller while the motor vehicle is driven on the closed-course track, a resident vehicle subsystem of the motor vehicle to execute a predefined vehicle operation based on the set of individualized feedback instructions specific to the driver. The commanding step may include delivering, via the system controller during the driving session on the closed-course track, the set of individualized feedback instructions to the driver through a coaching interface, such as an in-vehicle display device, wearable device, audio feedback system, or multi-modal delivery, for voluntary execution by the driver.

The method may also include collecting, via the system controller from a network of track sensors, sensor data indicative of real-time track surface conditions data of the track, wherein generating the individualized feedback instructions is further based on the real-time track surface conditions data.

The method may also include collecting, via the system controller from a network of environment sensors, sensor data indicative of real-time ambient driving conditions of the track, wherein generating the individualized feedback instructions is further based on the real-time ambient driving conditions of the track.

The method may also include modifying, via the system controller prior to the motor vehicle being driven on the closed-course track, one or more benchmark settings in the driving session parameters specific to the driver to offset select conditions in the real-time track surface conditions data and/or the real-time ambient driving conditions of the track.

The method may also include receiving, via the system controller from a driver graphical user interface (GUI), a driver-selected session type including a driver-selected objective, wherein generating the individualized feedback instructions is further based on the driver-selected objective of the driver-selected session type.

The method may also include: generating, via the system controller, a set of pre-session feedback instructions specific to the driver based on the driver-selected session type; and commanding, via the system controller, the driver GUI to display the pre-session feedback instructions to the driver.

The set of pre-session feedback instructions may include a recommended hardware change and/or a recommended vehicle modification determined to improve driving performance of the driver based on the driver-selected session type and the baseline driving goals and driving session parameters specific to the driver.

The method may also include: generating, via the system controller, a set of post-session feedback instructions specific to the driver based on the set of baseline driving goals and driving session parameters, the real-time vehicle telemetry data, and the real-time driver physiological telemetry data; and commanding, via the system controller, a driver graphical user interface (GUI) (or a multi-modal method) to display (and enable user-interaction with) the post-session feedback to the driver.

The method may also include: segmenting the closed-course track into a series of interconnected track segments; tracking a real-time location of the motor vehicle on the closed-course track; determining a respective track segment topography and/or a real-time track surface condition of a track segment in the series of interconnected track segments forward of the real-time location of the motor vehicle on the closed-course track; and commanding the resident vehicle subsystem to output an alert to the driver based on the respective track segment topography and/or the real-time track surface condition of the track segment forward of the real-time location of the motor vehicle. This may include delivering, via the system controller, a set of non-actuating feedback instructions to the driver through a resident vehicle interface or personal device.

Generating the set of individualized feedback instructions specific to the driver may include segmenting the real-time vehicle telemetry data and the real-time driver physiological telemetry data collected while the motor vehicle is driving into data subsets each specific to a respective zone of the closed-course track, and performing a comparative analysis of each of the data subset with a respective driver input model associated with the respective zone of the closed-course track.

The resident vehicle subsystem may include an audio system and/or a haptic system within a passenger cabin of the motor vehicle. In this instance, the predefined vehicle operation includes the audio system outputting an audio cue and/or the haptic system outputting a tactile cue indicative of one of the individualized feedback instructions.

The resident vehicle subsystem may include an augmented reality (AR) headset within a passenger cabin of the motor vehicle. In this instance, the predefined vehicle operation includes the AR headset displaying one of the individualized feedback instructions within a line of sight of the driver.

The resident vehicle subsystem may include a head-up display (HUD) device within a passenger cabin of the motor vehicle. In this instance, the predefined vehicle operation includes the HUD device displaying one of the individualized feedback instructions within a line of sight of the driver.

Aspects of this disclosure are also directed to a non-transient, computer-readable medium that stores instructions executable by a system controller of an integrated driver feedback system for optimizing driving performance of a driver of a motor vehicle on a closed-course track. These instructions, when executed, cause the system controller to perform operations comprising: retrieving a respective driver profile specific to the driver; determining, using the driver profile, a respective set of baseline driving goals and driving session parameters specific to the driver; receiving, from a system memory device, track topography data specific to the closed-course track; collecting, from a network of vehicle sensors and driver sensors while the motor vehicle is driven by the driver on the closed-course track, sensor data indicative of real-time vehicle telemetry data of the motor vehicle and real-time driver physiological telemetry data of the driver; generating, using a trained and supervised machine learning (ML) model, a set of individualized feedback instructions specific to the driver based on the set of baseline driving goals and driving session parameters specific to the driver, the track topography data, the real-time vehicle telemetry data, and the real-time driver physiological telemetry data; and commanding a resident vehicle subsystem of the motor vehicle to execute a predefined vehicle operation based on the set of individualized feedback instructions specific to the driver while the motor vehicle is driven by the driver on the closed-course track.

Aspects of this disclosure are also directed to a driver feedback system for a driver of a motor vehicle on a closed-course track. In this example, the driver feedback system includes a system memory device that store system data, a network of track sensors dispersed around the closed-course track, and a data communications interface that is operatively connected to the system storage device, the network of track sensors, and a network of vehicle (telemetry) sensors and driver (telemetry) sensors. The driver feedback system also includes a system controller that is programmed to: retrieve a respective driver profile specific to the driver; determine, using the driver profile, a respective set of baseline driving goals and driving session parameters specific to the driver; receive, from the system memory device, track topography data specific to the closed-course track; collect, from the network of vehicle sensors and driver sensors while the motor vehicle is driven by the driver on the closed-course track, sensor data indicative of real-time vehicle telemetry data of the motor vehicle and real-time driver physiological telemetry data of the driver; generate, using a trained and supervised machine learning (ML) model, a set of individualized feedback instructions specific to the driver based on the set of baseline driving goals and driving session parameters specific to the driver, the track topography data, the real-time vehicle telemetry data, and the real-time driver physiological telemetry data; and command a resident vehicle subsystem of the motor vehicle to execute a predefined vehicle operation based on the set of individualized feedback instructions specific to the driver while the motor vehicle is driven by the driver on the closed-course track. The commanding step may include the system controller delivering a set of feedback instructions to the driver through a resident vehicle interface or personal device, wherein these instructions correspond to individualized coaching generated during the session.

The system controller of the driver feedback system may be further programmed to collect, from the network of track sensors, sensor data indicative of real-time track surface conditions data of the track, wherein generating the individualized feedback instructions is further based on the real-time track surface conditions data.

The system controller of the driver feedback system may be further programmed to collect, from a network of environment sensors, sensor data indicative of real-time ambient driving conditions of the track, wherein generating the individualized feedback instructions is further based on the real-time ambient driving conditions of the track.

The system controller of the driver feedback system may be further programmed to modify one or more benchmark settings in the driving session parameters specific to the driver to offset select conditions in the real-time track surface conditions data and/or the real-time ambient driving conditions of the track.

The system controller of the driver feedback system may be further programmed to receive, from a driver graphical user interface (GUI), a driver-selected session type including a driver-selected objective, wherein generating the individualized feedback instructions is further based on the driver-selected objective of the driver-selected session type.

The system controller of the driver feedback system may be further programmed to: generate a set of post-session feedback instructions specific to the driver based on the set of baseline driving goals and driving session parameters, the real-time vehicle telemetry data, and the real-time driver physiological telemetry data; and command a driver graphical user interface (GUI) to display the post-session feedback instructions to the driver.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative smart driver feedback system for provisioning adaptive and individualized driver performance evaluation and training in accordance with aspects of the present disclosure.

FIG. 2 is a flowchart illustrating a representative driver feedback system control protocol for driver performance evaluation and training, which may correspond to memory-stored instructions that are executable by a resident or remote microcontroller, control module, logic circuit, central processing unit, or other integrated circuit (IC) device or network of circuits/modules/microcontrollers/IC devices (collectively “controller”) in accordance with aspects of the disclosed concepts.

FIG. 3 is a schematic illustration of a representative integrated smart driver feedback system for provisioning adaptive and individualized on-track driver performance evaluation and optimization in accordance with aspects of the present disclosure.

FIG. 4 is a flowchart illustrating a representative control protocol for an integrated driver feedback system for adaptive on-track driver performance optimization, which may correspond to memory-stored instructions that are executable by a system controller in accordance with aspects of the disclosed concepts.

FIG. 5 is a sequence of screenshots of a representative wireless-enabled handheld computing device with an interactive graphical user interface for provisioning adaptive and individualized on-track driver performance evaluation and optimization in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,”or any logical combination thereof, for example.

Presented below are Adaptive Driving Information Systems (ADIS) that evaluate track data, driver data, environmental data, and vehicle data to derive driver-specific feedback that is designed to help drivers optimize their on-track performance and experience. Data may be collected through various hardware devices and analyzed using advanced algorithms. The ADIS platform then generates personalized recommendations tailored to individual drivers and their specific objectives, such as lap time reduction, vehicle control, braking precision, or physiological targets (e.g., mental focus and stress reduction), etc. ADIS may integrate real-time feedback, interactive gamification elements, and a structured educational curriculum, e.g., to make high-quality driver coaching more affordable, scalable, and effective. The ADIS platform may employ both public and proprietary hardware and software, allowing it to adapt to existing and future technologies.

Disclosed driver feedback systems may be particularly beneficial for owners of private motorsport circuits, as well as for those interested in collecting driver data and autonomously improving racing techniques. Traditionally, such feedback oftentimes required one-on-one driver instruction. However, ADIS may replace private instructors by automating individualized driver feedback and skill advancement suggestions. ADIS's interactive and autonomous design may gamify the driving experience to engage drivers of all skill levels and enhance enjoyment both on and off the track. Additionally, the platform may promote on-track safety by encouraging drivers to practice safe driving habits by shifting the focus from competing against others to competing against personal statistics and historical behaviors.

The ADIS curriculum may be used alongside hands-on exercises to achieve skill mastery. The driver feedback system may recommend educational and skill courses to help drivers enhance their on-track performance, and may provide personalized recommendations for vehicle upgrades. By accessing a driver's unique profile, including their vehicle information, ADIS can suggest products to improve vehicle performance and address situational needs.

Rather than focus on a singular data source for providing driver coaching, which may lead to incomplete analysis and inchoate performance feedback, ADIS offers a holistic performance evaluation by integrating multiple interrelated data sources, such as vehicle dynamics and telemetry data, driver biometrics and behavior data, driver physiological telemetry data, real-time track conditions and environmental data, vehicle characteristics data, driver characteristics data, track characteristics data, etc. This multi-faceted approach helps to ensure that critical factors influencing driving performance are considered, providing precise and tailored feedback. Rather than providing single-action alerts for isolated incidents, such as those offered by existing collision avoidance systems (CAS) and other advanced driver assistance systems (ADAS), ADIS may continually monitor driver behavior and provide real-time feedback on systemic unsafe behaviors and patterns, such as improper braking, aggressive steering, and track-limit drifting. By focusing on customized self-improvement of the driver rather than automated operation of the vehicle, ADIS helps to reduce risky driver behavior and resultant accidents, promoting safer driving habits.

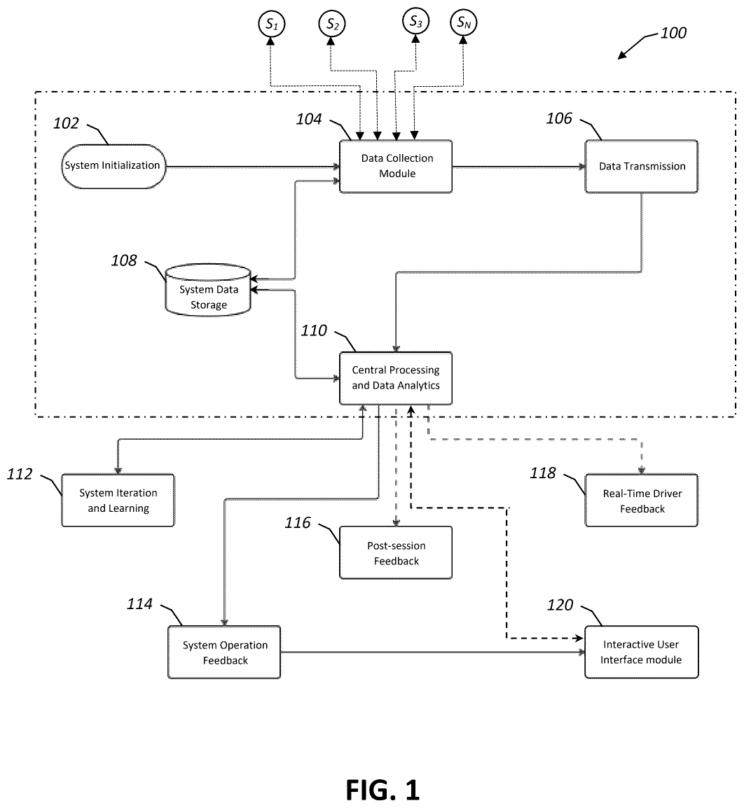

Referring now to the drawings, wherein like reference numbers refer to like features throughout the several views, there is shown in FIG. 1 a representative driver feedback system 100 for provisioning adaptive and individualized on-track driver performance evaluation and optimization. The illustrated driver feedback systems 100 and 300—also referred to herein as “Adaptive Driving Information System” or “ADIS”—are merely exemplary applications with which aspects of this disclosure may be practiced. In the same vein, execution of the present concepts for drivers of racecars on a closed-course racetrack should be appreciated as a non-limiting implementation of disclosed features. As such, it will be understood that aspects and features of this disclosure may be integrated into other driver feedback system architectures, implemented for assorted on-track and off-track driving scenarios, and utilized for any logically relevant type of motor vehicle.

The driver feedback system 100 of FIG. 1 may include a System Initialization module 102, e.g., with assorted user input controls and interactive graphical user interfaces (GUI), for initializing operation of the driver feedback system 100, which may include commencing a new driver session, calling up any related data objects and variables, initializing the ADIS platform, and preparing integrated system components. A Data Collection module 104 acts as a sensor system interface for communicating with a networked array of sensors S₁, S₂, S₃, . . . S_{N}, which may include on-track sensing devices, in-vehicle sensing devices, driver-wearable sensing devices, crowd-sourced sensing devices, ambient sensing devices, etc., to gather a predetermined set of information. This information may include track-specific data (e.g., surface conditions, surface temperature, debris, mapping, topography, etc.), vehicle-specific data (e.g., telemetry systems, engine performance, brake conditions, suspension type, tires pressures, fuel consumption, aerodynamics, diagnostics, etc.) and driver-specific biometric and physiological telemetry data (e.g., driver's physical and mental state, including heart rate, grip intensity, visual focus, fatigue level, etc.).

With continuing reference to FIG. 1, a Data Transmission module 106 aggregates the collected sensor data and, if desired, preprocesses (e.g., clean, transform, organize, etc.), filters, and fuses the aggregated data before transmittal to a central hub for evaluation and integration. The Data Transmission module 106 may utilize an iterative protocol for transforming raw sensor data into understandable and useable formats, and may synchronize the data in preparation for analysis and appropriate feedback delivery. A System Data Storage device 108, which may be in the nature of a server-class database or cloud-computing storage service, may collate, map, and store some or all collected and analyzed data for future reference and trend analysis. The ADIS platform 100 may allow drivers, owners, and/or other verified users to call-up, review, modify, and store session data and system information.

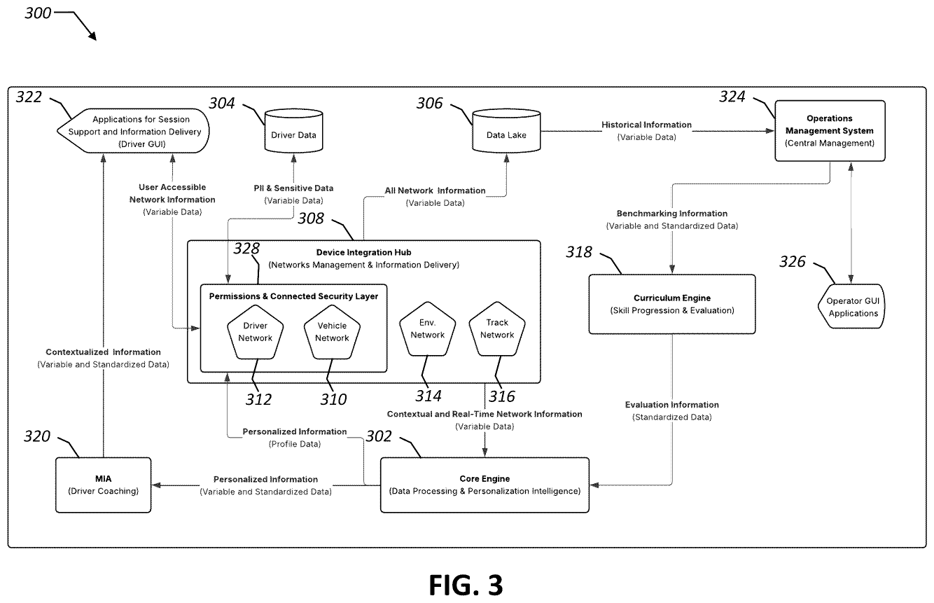

A Central Processing Unit (CPU) 110, which may be in the nature of a resident or remote microcontroller, control module, programmable logic device, central controller, or network of controllers/modules/devices, analyzes integrated data, e.g., using advanced algorithms and multi-functional ML-powered subsystems to assess performance during the driver session and identify areas for improvement. As used herein, the term “system controller” may refer to a coordination of logic within the ADIS platform and may include or interact with other subsystems responsible for managing and executing platform functions. In the illustrated example, the System Initialization module 102, Data Collection module 104, Data Transmission module 106, System Data Storage device 108, and CPU 110 are shown integrated into a single computing node, such as a server-class back office (BO) computing terminal; nevertheless, one or more or all of these components may be segmented into separate nodes and offboarded in a networked computing fashion. Moreover, it is envisioned that any of the features and options described herein with respect to the driver feedback systems 100 of FIG. 1 may be incorporated, singly or in any combination, into the ADIS architecture 300 of FIG. 3, and vice versa.

A System Iteration and Learning module 112 may implement a trained and supervised deep neural network (DNN) machine learning (ML) model, a trained gradient-boosting, ensemble learning ML model, a supervised decision-tree ML model, or other suitable technique to analyze preprocessed, filtered, and fused data to generate a set of individualized feedback instructions specific to a subject driver. ADIS 100 may continuously improve algorithms and feedback mechanisms based on historical data and machine learning models. Regular updates may be deployed to enhance system capabilities and integration with new technologies. A System Operation Feedback module 114 may track individual driver progress over time, and provide benchmarking, historical metrics, and statistics for use by drivers and owners of the system 100. System operating feedback data may be output to an Interactive User Interface module 120, which outputs an interactive GUI that enables a driver, track operator, or other verified user to call-up, view, analyze, modify, selectively process (e.g., filter, graph, mark-up, etc.) and store data and, when applicable, to provoke system-level changes.

A Post-session Feedback module 116 may generate and deliver detailed reports post-session, offering in-depth insights and recommendations ranging from skill building and educational courses, vehicle hardware upgrades, physical wellness opportunities, and other feedback to help a driver improve based on their objectives and performance. Gamification elements, such as driver-tailored challenges and individually awarded badges, may be implemented to motivate regular engagement and continuous improvement. A Real-time Feedback Delivery module 118 may process applicable data in real-time to provide immediate feedback and alerts. The driver feedback system 100 may tailor its analysis based on a subject driver's selected “primary” objectives (e.g., lap time reduction, vehicle control, braking precision, physiological targets, etc.).

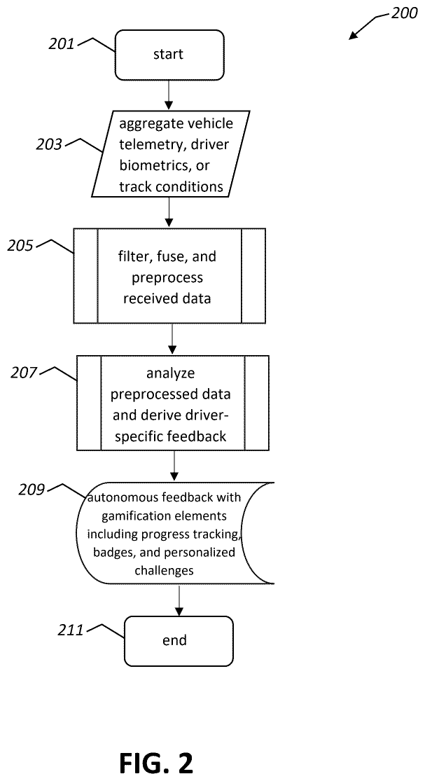

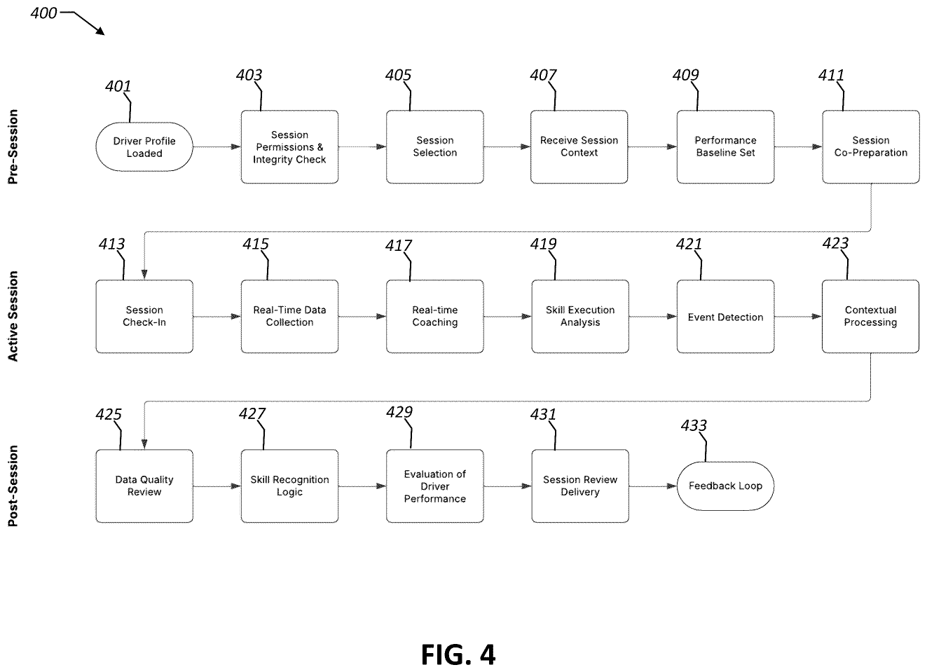

With reference next to the flowchart of FIG. 2, an improved method or control protocol for operating a driver feedback system, such as closed-course racetrack driver feedback system 100 of FIG. 1, to provision adaptive and integrated on-track driver performance optimization is generally described at 200 in accordance with aspects of the present disclosure. Likewise, FIG. 4 illustrates an improved method or control protocol 400 for an integrated driver feedback system for adaptive on-track driver performance optimization. Some or all of the operations illustrated in FIGS. 2 and 4, and described in further detail below, may be representative of an algorithm or algorithms that correspond(s) to or implemented as non-transitory, processor-executable instructions that may be stored, for example, in main or auxiliary or remote memory (e.g., System Data Storage device 108 of FIG. 1). These instructions may be executed, for example, by an electronic controller, processing unit, dedicated control module, logic circuit, or other module or device or network of controllers/modules/devices (e.g., CPU 110 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated. For instance, any of the control processes illustrated in the method 200 of FIG. 2 may be incorporated, singly or in any combination, into the method 400 of FIG. 4, and vice versa.

Method 200 begins at START terminal block 201 of FIG. 2 with instructions to initialize operation of the driver feedback system. Method 200 advances to DATA COLLECTION process block 203 and aggregates vehicle telemetry data, driver biometrics and/or physiological telemetry data, track conditions data, and/or any of the other data and relevant information described above. Collected data may be filtered, preprocessed and fused DATA PROCESSING subroutine 205. The preprocessed data may be concurrently analyzed at DATA ANALYSIS subroutine 207 to derive driver-specific feedback. Advancing to INTERACTIVE USER INTERFACE process block 209, the method 200 provides autonomous feedback with gamification elements including progress tracking, badges, and personalized challenges. Upon completion of some or all of the control operations presented in FIG. 2, method 200 may advance to END terminal block 211 and temporarily terminate or, optionally, may loop back to terminal block 201 and run in a continuous loop.

Disclosed ADIS platforms may be constructed as modular performance intelligence systems that are built to deliver comprehensive, personalized, and context-aware coaching for motorsport drivers and track operators. Designed to function seamlessly across real-time and asynchronous contexts, ADIS may unify a suite of intelligent components—including telemetry integration, benchmarking engines, AI-driven coaching, and operator controls—to support skill development and system optimization. ADIS may employ data-driven learning models and feedback loops that adapt to each driver's current learning objective(s). Rather than overwhelming a driver with raw data, ADIS may identify and prioritize the most impactful opportunities for growth, helping drivers progress systematically through a personalized curriculum.

During each session, ADIS may collect data about connected vehicle telemetry, driver physiology, environmental conditions, and track characteristics to derive real-time or near-real-time feedback to the driver before, during, and after track activity. ADIS may evaluate individual driver performance against personalized or system-wide benchmarks and may concomitantly recommend drills, product upgrades, and/or driving technique adjustments to help optimize driver performance. To align with operational standards and track-specific configurations, ADIS may be integrated with an Operator Management System that is configured as a control layer used by track operators and system owners to define performance goals, manage session operating conditions, and supply critical context to the curriculum and core engines. The OMS may facilitate both standardized data (e.g., baseline track expectations, safety margins, etc.) and variable data (e.g., weather, traffic, equipment differences, etc.) to influence session scoring and driver evaluation. By uniting precision engineering with scalable driver education, the ADIS platform is effective for professionals and approachable for enthusiasts—providing comprehensive, personalized, and context-aware performance coaching for motorsport drivers.

Presented in FIG. 3 is an example of an ADIS architecture 300 that may be embodied as a modular, cloud-connected performance coaching platform deployed at a closed-course motorsports facility. The ADIS architecture 300 may operate as an integrated ecosystem comprising both driver-facing and operator-facing components to provide real-time and post-session coaching to drivers based on multi-source telemetry data and objective-based evaluation logic. In accord with the illustrated example, the system is composed of at least the following core components:
1. a Core Engine 302 (e.g., dedicated subsystem processor) that receives and analyzes real-time data streams from multiple sources, such as driver-specific data stored in a Driver Database 304 and network-specific data stored in a Data Lake Database 306;
2. a Device Integration Hub 308 (e.g., context-aware multiport networking component) that ingests real-time telemetry data output from a subject “host” vehicle (e.g., via Vehicle Network 310), real-time driver data of a subject driver (e.g., via Driver Network 312), real-time ambient driving conditions data of a subject driving session (e.g., via Environmental Network 314), and real-time track conditions data of a subject closed-course track (e.g., via Track Network 316);
3. a Curriculum Engine 318 (e.g., cloud-based digital platform) that compares and interprets session performance metrics against structured skill progression milestones to evaluate driver performance;
4. a Motorist Information Assistant (MIA) 320 (e.g., self-contained software module) that provides context-aware coaching to drivers through system-automated audible, visual, haptic, and/or augmented reality (AR) interfaces, e.g., collectively represented by a Driver Feedback (GUI/HUD/AR/VSS) Interface 322;
5. an Operations Management System (OMS) 324 (e.g., server-class computing terminal and network backbone) through which track operators may define performance criteria, safety margins, feedback standards, etc., using an interactive Operator GUI Interface 326; and
6. a Permissions & Connected Security (Privacy) Layer 328 (e.g., role-based access control (RBAC) device) that enforces data governance and user-defined access controls.
   The foregoing components operate independently and in coordination with one another to deliver personalized coaching aligned with each driver's selected learning objective(s).

The Core Engine 302 of FIG. 3 may act as a centralized intelligence layer that powers data analysis, benchmarking, and personalized feedback delivery. For instance, the Core Engine 302 processes incoming data received from each variable network—Vehicle Network 310 Driver Network 312, Environmental Network 314, and Track Network 316—via the Device Integration Hub 308. Using machine learning and decision logic, the Core Engine 302 identifies data patterns, evaluates driver performance, and generates real-time or pre/post-session insights. The Core Engine 302 may continuously adapt ADIS 300 using historical data, driver feedback, and reinforcement learning, and informs MIA 320 how and when to generate personalized feedback and adapt to new information over time.

With continuing reference to the example ADIS architecture 300 of FIG. 3, the Device Integration Hub 308 may act as a system interface that manages communication with numerous system-supported hardware devices, sensors, and platforms. This Hub 308 helps to ensure seamless data intake across a wide range of third-party and proprietary devices through SDKs, APIs, and modular firmware compatibility. Additionally, the Hub 308 may handle device registration, synchronization, diagnostics, and error mitigation, e.g., to enable ADIS 300 to remain hardware-agnostic and scalable.

The Vehicle Network 310 may operate to both connect ADIS 300 to, and also interpret sensor-generated data received from, onboard vehicle hardware. By way of example, Vehicle Network 310 may ingest and standardize inputs from vehicle ECUs, CAN systems, OBD-II ports, GPS, IMUs, and other sensors. Network 310 may also facilitate cross-compatibility (hardware agnostic) with any suitably equipped vehicle make/model, thereby enabling ADIS 300 to work across a wide spectrum of vehicle platforms. It may be desirable that the Vehicle Network 310 monitor real-time mechanical performance, retrieve system faults, identify inefficiencies, and correlate vehicle behavior with driver inputs. Comparatively, the Driver Network 312 may be a secure, cloud-based system that manages intake and management of driver-specific data, profiles, and behavioral insights. This Network 312 facilitates the storage of personal information, historical performance data, training goals, physiological telemetry patterns, and skill progression. Driver Network 312 of FIG. 3 may also enable seamless access to personalized benchmarks, recommendations, and content regardless of track or session, and may help to enable the MIA 320 to recognize individual tendencies and adapt coaching accordingly with the Core Engine 302.

The Environmental Network 314 may take on the form of a data layer that captures and contextualizes external conditions that affect driving performance and safety. This may include weather APIs, on-track environmental sensors (e.g., humidity, wind, temperature, etc.), and predictive analytics. Moreover, the Environmental Network 314 may evaluate each set of recommendations and assessments to help ensure they are accurate to the surrounding conditions, which may necessitate modifications such as adjusting for grip, visibility, engine load, and more. In comparison, the Track Network 316 may be a digital infrastructure layer that maps and monitors physical track data, live traffic, and dynamic localized conditions (e.g., debris, water patches, rubber buildup, etc.). For instance, the Track Network 316 may provide detailed track mapping, including track corners, sector segments, elevation changes, braking markers, pit lane, and the like. Track Network 316 may also monitor current track use conditions, such as the positions and behaviors of other drivers on the circuit. It may be desirable that the Network 316 support strategic racecar training and safety alerts. The Track Network 316 may be central to segment-based coaching and benchmarking and may support content for post-session analysis.

Permissions & Connected Security (PCS) Layer 328 of FIG. 3 may be a secure data management system that governs how driver data and vehicle data is accessed, stored, and shared within the ADIS architecture 300. This Layer 328 may provide users with control over their personal data, which may include biometrics data, Personally Identifiable Information (PII), session history data, and performance analytics data. To this end, a driver may manage visibility settings, enable or restrict benchmarking comparisons, and audit/restrict use of their data. The Operational Management System 324 may be embodied as an operator-controlled application within ADIS 300 that governs track-wide standards, optimizations, and data inputs. OMS 324, for example, may act as a central management hub where track operators and their authorized personnel define desired performance outcomes, program track-specific settings, and monitor driver and vehicle activity.

Continuing with the discussion of FIG. 3, the Curriculum Engine 318 may be a structured skill development framework that maps driver behavior to a personalized progression system. By way of non-limiting example, the Curriculum Engine 318 may evaluate session performance against predefined skill milestones and benchmarks (e.g., braking consistency, apex timing, top speed, etc.) and, if desired, statistics of other driver averages as a whole. Curriculum Engine 318 may generate suggestions for targeted drills and vehicle upgrades for driver improvement while helping to ensure that all feedback is aligned with a long-term driver development path.

The Motorist Information Assistant 320 may be an intelligent, interactive AI-driven system that functions as a real-time driver coach and feedback assistant. In an example, MIA 320 may deliver tailored guidance across all stages of a session—before, during, and after—based on live telemetry, driver input, and contextual data. MIA 320 may communicate with a driver using in-cabin vehicle sound system (VSS) components, AR overlays, digital UI prompts, haptic cues, and other methods as technology evolves. In addition, MIA 320 may provide simulated human responses that are comparable to a human driver coach, including answering questions, engendering driver interest, reinforcing good habits, communicating relevant session information, and suggesting training or equipment upgrades. MIA 320 may continuously learn from driver performance, feedback, and environmental data to provide increasingly personalized support.

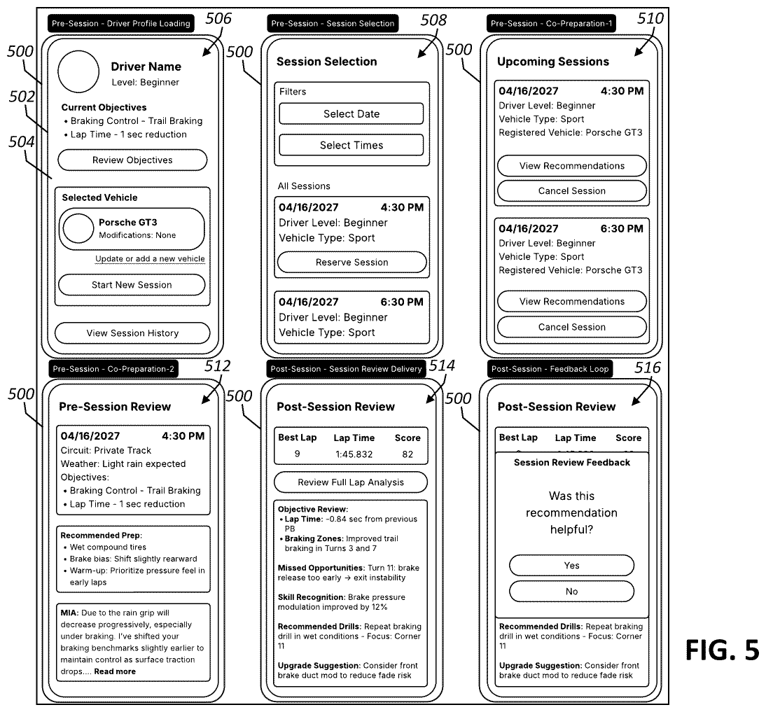

To initialize and manage session data, the Core Engine 302 may retrieve a driver profile and a set of session context information to aggregate driver-selected objectives, vehicle setup, track configuration, and context for a new driving session. A “session context” may be typified as a total set of inputs for a given session (e.g., driver profile, driver objectives, vehicle information and setup, track conditions, etc.). A “driver profile” may be a comprehensive collection of driver-specific data, including session history, skill level, physiological metrics, hardware setup, and training objectives, that may be stored in the Driver Database 304 or retrieved through the Driver Network 312. The driver profile may be shown in an Application for Session Support and Information Delivery (e.g., via a user-facing interface (e.g., GUI app, head-up display (HUD) device, digital instrument cluster, audio/AR device) to deliver session data, insights, prompts, and feedback to drivers before, during, and after sessions. Examples of the types of data that may be contained in a Driver Profile are shown in the examples presented in FIG. 5.

To receive and integrate data from multiple sources, the Device Integration Hub 308 aggregates telemetry and contextual data from connected hardware, Application Programming Interfaces (API), and third-party Software Development Kits (SDK), while supporting driver, vehicle, environmental, and track inputs. Real-time driver performance analysis may be performed by the Core Engine 302 using a Skill Execution Model and a Segment-Aware Analysis protocol to evaluate segmented inputs (e.g., brake, throttle, line choice, etc.) against personalized or benchmark targets in real-time. The Skill Execution Model and Segment-Aware Analysis protocol may be internal ML processes operating within the Core Engine 302. The MIA driver coach 320 may deliver personalized driver feedback by generating and outputting step-by-step instructions and customized coaching via audible, visual, tactile, and/or AR feedback based on active objectives and session state.

To prioritize feedback based on driver-specific objectives, the Core Engine 302 uses an objective filtering algorithm (e.g., herein described Objective-Based Feedback Prioritization) to dynamically filter feedback based on curriculum priorities and selected session goals (e.g., braking, cornering, lap time, etc.). The objective filtering algorithm may be a dynamic prioritization mechanism that evaluates incoming data from the session context and selectively filters which coaching feedback to generate or suppress during a particular session. The Curriculum Engine 318 may use one or more benchmarking models to actively adapt benchmarks across time and conditions, including adjusting benchmarks using predictive learning models and memory of prior session context across drivers, vehicles, and weather. A predefined set of benchmarking models may be a predictive, comparative, and adaptive data subsystem subroutine within ADIS 300 to generate, adjust, and validate performance targets against which a driver's behavior is evaluated. These models may analyze aggregated data from historical sessions, vehicle configurations, environmental conditions, and user-specific performance trends to establish Global Benchmarks (all user and simulated data), Personalized Benchmarks (single user), and Calculated Optimal Benchmarks (e.g., Calculated Optimal Lines).

To enable track operator oversight and configuration of ADIS 300, the Operations Management System 324 enables track managers and authorized personnel to define rulesets, set safety parameters, and establish feedback standards that govern system-wide driver evaluations. The Core Engine 302 may employ a session visualization engine and driver-accessible GUI applications (e.g., Driver GUI interface 322) for post-session review and scoring by compiling session results, overlaying driver inputs, and presenting coaching summaries through digital reports. The session visualization engine may be embodied as an integrated module that generates replays and visual representations of session data, including overlays of input data, racing line comparisons, and progress charts. The Permissions & Connected Security (Privacy) Layer 328 may control data access and permissions to ensure driver and operator data rights are protected, allowing granular control over session visibility, benchmarking, and third-party access.

For closed-loop feedback control, the ADIS architecture 300 of FIG. 3 may employ a Reinforcement Learning Loop and a Feedback Loop Integration protocol (e.g., both integrated into a closed-loop feedback (CLF) microcontroller) to learn from user feedback to adjust future coaching behavior based on driver ratings, progression metrics, and feedback accuracy. The reinforcement learning loop (RLL) may be a system-driven feedback mechanism within ADIS 300 that enables automated and/or manual refinement of coaching behavior and performance predictions over time based on observed driver outcomes and direct user feedback. This RLL CLF subsystem may be used by the Core Engine 302 for coaching refinement, the MIA 320 for feedback personalization, the Curriculum Engine 318 for long-term learning adjustment, and the Post-Session Feedback Loop (e.g., Post-session Feedback module 116) for feedback delivery refinement.

A Persistent Context Engine (PCE) may provide session memory and cross-session context by retaining unresolved feedback and objective tracking to influence future session setups and recommendations. The Persistent Context Engine may be a subsystem within ADIS 100 that is responsible for storing, retrieving, and applying session-specific memory across multiple driving events. The PCE may retain specific historical data, including coaching suggestions, past objectives, environmental conditions, performance outcomes, etc.) to enable adaptation of feedback, benchmarking, and session setup.

During operation of the ADIS architecture 300, vehicle telemetry may be acquired via OBD-II, CAN, or custom ECUs, while driver physiological may be gathered through wearable sensors and in-cabin sensing devices. Environmental conditions may be retrieved via on-track sensors and weather APIs, whereas track data may be derived from a pre-mapped geometry and real-time traffic conditions. Hardware devices may be registered through the Device Integration Hub 308 using SDKs and/or APIs, with hardware-agnostic operation enabled by modular abstraction layers. Feedback from the MIA 320 is ideally delivered using mixed modalities, such as: (1) real-time audio cues (e.g., “ease throttle”, “brake earlier”); (2) visual overlays (e.g., augmented racing lines, input markers, etc., displayed within the driver's field of view using an HUD device or AR headset); (3) haptic signals (e.g., steering wheel vibration, accelerator pedal vibration, gear-shift knob vibration, etc.); and (4) GUI-based post-session dashboards with overlays of skill inputs and benchmark deltas. The MIA's feedback logic may use an objective-aligned filtering algorithm that draws from both global and personalized benchmark data.

ADIS architecture 300 may also contain an Operator Control Layer that enables track operators to access the OMS 324 through a secure dashboard. In this instance, a track operator may: (1) define skill benchmarks at the segment level and full-lap level; (2) program rulesets for safety margins, environmental overrides, and session eligibility; and (3) monitor driver progression across multiple sessions and adjust curriculum complexity as needed. Operation of the ADIS architecture 300 may necessitate persistent internet connectivity (e.g., cloud-synced driver network and real-time analytics) with a real-time data ingestion latency of less than about 250 milliseconds (ms). It may also be desirable that driver telemetry and vehicle telemetry sampling rates exceed approximately 10 Hertz (Hz) with all compatible devices registered and verified via the Permissions & Connected Security Layer 328. In degraded operating scenarios (e.g., limited connectivity), ADIS 300 may revert to an offline post-processing mode. While not essential in all deployments, ADIS 300 may offer integration with racing simulators in a Simulated Environment Mode, may support group coaching sessions via an Operator-Controlled Group Mode, and may feed read-only data displays for spectators in a Spectator Insight Mode. A Product Recommendation Engine may link performance gaps to aftermarket equipment.

ADIS 300 may operate through three core operational processes, namely a Pre-Session process, an Active Session process, and a Post-Session process, each of which is supported by the system's integrated hardware and software components. Presented in FIG. 4 is an example of a session lifecycle workflow that may be performed during operation of the ADIS architecture 300 of FIG. 3. During a pre-session segment of the lifecycle methodology 400, the system 300 loads a respective driver profile of an individual driver at DRIVER PROFILE process block 401. ADIS 300 may retrieve and load a driver profile that contains past session performance, vehicle setup preferences, driver skill level data, and other known driver information to personalize the session options and other informational context. In tandem, ADIS 300 may acquire and validate session permissions and conduct a system integrity check at PERMISSION & INTEGRITY process block 403. For instance, Device Integration Hub 308 may verify that data streams from connected hardware are operational and synced, and may notify the driver or OMS 324 if and when supplemental information, system calibration, and/or vehicle diagnostics are needed. The system 300 may also verify the driver has set up the necessary elements for the PCS Layer 328 in the driver profile to enable session analysis and/or track access.

Method 400 may advance to SESSION SELECTION process block 405 and prompt the track operator or driver to select a desired session type. By way of example, a driver may select a track session and an objective for that session. Session selection may also include selecting a vehicle make/model, a vehicle trim package, a session date/time/length, a desired coaching package, etc. Between sessions, ADIS 300 may carry persistent context, like prior coaching suggestions, installed hardware upgrades, and adaptive benchmark changes, to help inform driver's session selection and setup decisions. Once a track session is selected, method 400 may retrieve historical context data at SESSION CONTEXT process block 407. The Core Engine 302, for example, collects context-relevant information provided by the driver (e.g., session, vehicle, objective, etc.) and the Device Integration Hub 308 collects track and environment related data (e.g., checks for available connected hardware for the session and monitors for changes in variable network data).

In addition to receiving session context information, ADIS 300 establishes session goals and baseline parameters at BASELINE process block 409. At this juncture, session goals may be set via the Core Engine 302 and the Curriculum Engine 318 using global, local, and/or personalized benchmarking information relevant to the driver's predefined objective(s); a driver may have more than one ongoing or session-specific objective. To complete the pre-session segment, ADIS 300 may concurrently validate hardware readiness at SESSION PREP process block 411. Here, the MIA 320 and/or applications for session support and information delivery may inform the driver of current track conditions and, optionally, may recommend available products and/or vehicle modifications that could help ensure better performance based on the driver's objective(s).

After completing all necessary pre-session procedures, method 400 executes an active session by first conducting driver registration and introduction procedures at SESSION CHECK-IN process block 413. During session check-in, ADIS 300 initiates session tracking when the driver and vehicle are confirmed active, e.g., via biometric verification and vehicle transponder, prior to proceeding into the session and onto the track.

From there, ADIS 300 aggregates real-time vehicle dynamics and telemetry data at DATA COLLECTION process block 415. At this juncture, data is ingested from some or all available connected hardware via the Device Integration Hub 308. Intra-driving instructions are provided to the driver during the driving session at REAL-TIME COACHING process block 417. For instance, the driver may receive customized instructions, alerts and visual/audible/haptic cues through connected in-vehicle and wearable hardware. Drivers may also receive live feedback and instructions from an instructor or operator to supplement the system-automated coaching and operations.

During the Active Session, real-time telemetry data is analyzed using segmented track logic, as indicated at SKILL EXECUTION ANALYSIS process block 419. Performance through each of the track segments (e.g., laps, corners, braking zones, etc.) may be evaluated in real-time by the Core Engine 302 to monitor the driver's progress of objectives against personalized benchmarks. The MIA 320 may deliver in-session feedback that is prioritized according to the driver's predefined objectives as well as current driving conditions. ADIS 300 may monitor for any of an assortment of potential driving events at EVENT DETECTION process block 421. For instance, the Core Engine 302 monitors for, identifies, and flags abnormal performance conditions (e.g., wheel lock, sudden deceleration, off-Track excursions, etc.) to selectively update the real-time feedback and post-session analysis provided to the driver. ADIS may construct a comprehensive set of session context conditions at CONTEXTUAL PROCESSING 423. Active session segment data, for example, may be broken into zones in the Core Engine 302 for comparative analysis (e.g., turn-in point, apex, exit, etc.) with driver input modeling (e.g., steering angle, pedal pressure, gear shifts, etc.) to assess skill execution.

Upon conclusion of the active driving session, method 400 may thereafter conduct a post-session segment and compile a performance report with skill ratings, benchmark comparisons, and targeted recommendations. Each post-session segment may begin with evaluating the quality of collected sensor data and, where applicable, preprocess (e.g., clean, transform, organize, etc.), filter, and fuse the data at DATA QUALITY REVIEW process block 425. For Data Quality Review, the Device Integration Hub 308 may normalize and clean a full set of session data to be stored as historical information, which may also add context for the learning models within select system components, like the Core Engine 302 and OMS 324. Session data is prepared for final analysis in the Core Engine 302, which is then shared in the post-session review. From there, SKILL RECOGNITION LOGIC process block 427 evaluates segmented inputs against personalized goals and benchmark targets. By way of example, the driver's performance data is compared against benchmarked performances in the Core Engine 302 with support from the Curriculum Engine 318.

An individualized driver performance assessment is concomitantly conducted at DRIVER EVALUATION process block 429 which is then transmitted to the driver at SESSION REVIEW process block 431. A session score and detailed performance breakdown (e.g., map of actual racing lines vs. optimal racing lines, late braking moments, areas with inconsistent throttle, etc.) may be generated via the Core Engine 302 and applications for session support and information delivery. The Core Engine 302 also logs related driver progress and performance into the driver's profile; the session report is concurrently delivered to the driver via the MIA 320 and/or driver GUI applications 322. The full session report may include a progress summary along with a performance score and suggested follow-up training or products. The report may provide access to more detailed performance and segment breakdowns with driver input overlays and a timeline of performance moments.

Prior to terminating the session lifecycle workflow, ADIS 300 may collect and analyze user feedback and system feedback in order to modify system operating parameters and coaching procedures based on driver ratings, progression metrics, feedback accuracy, etc., at FEEDBACK LOOP process block 433. The MIA 320 and other applications for session support and information delivery may incorporate user feedback through driver engagement with session reports and requested feedback (e.g., “Was this recommendation helpful? ”, “Which report do you prefer?”, “Were my coaching suggestions helpful?”). To optimize system operation and improve driver performance evaluation, ADIS 300 may identify a predefined set of reference setpoints (desired outputs) and then monitor system feedback elements (measure actual outputs) that are each compared to a respective reference setpoint. An error detector subroutine compares the reference setpoints to the system feedback elements to detect the presence of any errors (e.g., aberrations outside a preset threshold). If an error is detected, ADIS 300 analyzes the error characteristics and adjusts its related system procedures correspondingly to obviate the likelihood of a similar future error. The foregoing process may be systematically repeated to create a closed loop in which ADIS 300 persistently monitors and adjusts its operating parameters to maintain the desired setpoints.

FIG. 5 presents a sequence of screenshots of a representative wireless-enabled handheld computing device 500 with an Organic Light-Emitting Diode (OLED) high-definition (HD) touchscreen display 502 that presents an interactive GUI 504 that displays an assortment of available user-selectable applications along with associated application modules with data sets that are selectable for viewing, analysis, modifications, processing, transmission, and storage. A pre-session Driver Profile module 506 loads a driver profile for a subject driver that includes their respective historical session data, skill level, vehicle hardware setup (manual transmission, performance tires, etc.), and past coaching outcomes, if present. In the illustrated example, the MIA 320 notes that this particular driver has previously struggled with inconsistent brake modulation in wet conditions.

After loading the driver profile, ADIS 300 conducts a permissions and integrity check to confirm, for example, the driver's physiological telemetry and biometric wearables and the vehicle's steering wheel sensors and vehicle telemetry systems are live and synced. Privacy settings may restrict session data visibility to the driver only. A pre-session Session Selection and Context Construction module 508 presents the driver with one or more selectable options: a session date, a session time, a vehicle type, and a session objective (trail braking-focused lap goal). The Core Engine 302 may receive the driver-selected objectives as well as live weather data (“rain incoming”) and track-specific variables (“low grip”, “slight standing water in sector 2”). A Co-Prep Selected Session module 510 presents the driver with a list of upcoming sessions, each of which includes a respective set of session recommendations provided by ADIS 300 and user-selectable options for modifying or cancelling the session.

With continuing reference to FIG. 5, the interactive GUI 504 pay present the user with a Pre-Session Review module 512 that enumerates the session details and settings, a series of sessions preparation steps provided by ADIS 300, and a customized pre-driving coaching segment provided by MIA 320. At this time, ADIS 300 may conduct a performance benchmark calibration in which the Curriculum Engine 318 may adjust session benchmarks (e.g., braking benchmarks revised downward due to wet surface), referencing both global and personalized session data under similar conditions. MIA 320 may generate context-specific instructional cues and flags, such as for risky braking zones, prior to commencing the driving session. Pre-driving coaching via MIA 320 may also advise the driver that “Conditions are slick in sector 2. Trail braking focus is activated. Stay smooth on pedal release. Let's aim to shave 1.0 second while keeping clean exits. Be mindful of early throttle in wet segments.”

During active driving, ADIS 300 may initiate a session by first validating the driver's identity and confirming the registered vehicle has entered the track through an assigned pit lane. For real-time driver coaching and vehicle dynamics tracking, ADIS 300 may actively track the vehicle's real-time location to derive location-specific track characteristics and conditions to produce “on the fly” driver recommendations for optimizing driver performance. As a driver enters “Turn 5”—a known heavy braking zone—ADIS 300 may detect a spike in brake pressure and automatically generate a driver alert of a potential brake system lock-up. MIA 320 may coordinate with Driver Feedback Interface 322 to output immediate auditory guidance to the driver (“DRIVER ALERT: ease brake pedal; let weight transfer settle; exit speed target of 45 mph”). A segment-level skill evaluation may be conducted by the Core Engine 302, which may include segmenting the track into lap zones, analyzing respective data subsets ingested by ADIS 300 while the driver traversed the individual lap zones, and evaluating the driver's performance for each lap zone. By way of example, and not limitation, Sector 2 of a closed-course racetrack may log excessive rear brake bias and mid-corner throttle hesitation by a driver under evaluation; these data points may be flagged for post-session review. Likewise, ADIS 300 may flag occurrence of detected events within each track segment (e.g., wheel-lock event in turn 7), and initiate real-time feedback and tagging for in-depth review.

A post-session Session Review Delivery module 514 may perform data structuring and storage, including formatting, fusing, and normalization of all session data. In addition, the system's internal models may be modified in light of changing ambient and track conditions (e.g., grip model updated to reflect evolving rain conditions). Driver inputs and physiological telemetry/biometric stress responses may be archived for historical context, and performance scoring with attendant system-generated recommendations are provided. Session summary information, such as a session score (e.g., 82/100) and a session performance comparison (e.g., driver reduced lap time by 0.84 seconds; improved brake release in wet corners) may be generated and output to the driver. In the illustrated example, MIA 320 may recommend “Good progress. You dropped 0.84 sec overall. Let's drill turn 7 with lighter pedal initiation next session. Consider adjusting rear brake bias +5% forward.” An optional Feedback Loop module 516 presents the driver with selectable inputs for rating the pre-session, intra-session and post-session feedback (helpful vs. unhelpful); the responses may be fed into the Reinforcement Learning loop to refine future prompts for similar conditions.

As used herein, the following terms may be defined to include the following:

Active Session: designated time period when a driver is engaged in a live driving activity on a track or roadway, during which ADIS collects, processes, and responds to real-time data inputs for performance coaching, event detection, and benchmarking.

Active Session Segment Data: time-synced, zone-specific data captured during a live session, which may be segmented by track features (e.g., turn-in, apex, exit, etc.) for detailed analysis of driver input and performance.

Adaptive Driver Information System (ADIS): automated, AI-driven driver performance monitoring, evaluation and feedback system composed of interdependent components, data structures, and operational processes that work together to deliver personalized, context-aware coaching to drivers; a full ecosystem of software, networks, AI models, and hardware integration that delivers personalized Driver performance analysis and real-time coaching.

Applications for Session Support and Information Delivery: user-end interfaces (e.g., GUI apps, HUDs, audio components, AR devices, haptic transducers, and other connected hardware) that deliver session data, insights, prompts, and feedback to drivers before, during, and after sessions.

Average Optimal Line: track-specific optimal racing line derived from cumulative driver and vehicle data over time; ADIS uses machine-learning models to refine this line with variables like surface changes, driver and vehicle behavior and response data, and other trends seen in real-world events. Over time, the system generates a more accurate real-world version of a circuit's Optimal Racing Line for Driver sessions.

Benchmark: target performance value derived from professional, personalized, average optimal line, and/or other data used to guide and assess driver improvement.

Benchmarked Performances: historical session performances or simulations that represent target conditions against which current driver performance is compared.

Benchmarking Information: compiled data of personalized, global, or averaged performance targets used to drive driver evaluation, session scoring, and skill analysis.

Benchmarking Models: algorithmic structures that evaluate Driver performance against static, dynamic, or personalized reference data. These models may include predictive and comparative functions and may evolve through accumulated session data across similar conditions, vehicles, or drivers.

Calculated Optimal Line: simulated “best-case” racing line determined using algorithmic modeling (e.g., dynamic programming, genetic algorithms, etc.), tailored to specific track, track conditions, vehicle setup, driver objectives, etc.

Connected Hardware: devices and sensors used to collect and/or deliver real-time data and feedback, including on-vehicle telemetry units, driver-worn physiological telemetry and/or biometric sensors, wearable electronics, vehicle dynamics sensors, AR glasses, in-vehicle HUDs, centerstack telematics, digital instrument clusters, and occupant monitoring systems.

Connected Security Network: authentication layer that verifies driver identity and vehicle registration, e.g., using biometrics, vehicle transponders, and track session access protocols.

Core Operational Processes: three-phase operational flow of ADIS, namely Pre-Session, Active Session, and Post-Session; these phases govern how data is collected, processed, and used to inform Driver improvement.

Curriculum: skill progression framework established by the Curriculum Engine that aligns feedback and training recommendations with structured driver development goals.

Curriculum-Aligned Skill Development Engine: subsystem that maps individual session performance to a long-term skill acquisition framework. It evaluates driver progression against structured milestones and dynamically adjusts training priorities and recommendations in alignment with the curriculum.

Driver: vehicle operator and application user actively participating in track session.

Driver and Vehicle GUI Applications: interface applications that present session data, progress reports, recommendations, and controls to drivers and operators.

Driver Input Modeling: sub-process that interprets raw steering, braking, throttle, and shifting actions for performance evaluation.

Driver Profile: comprehensive collection of driver-specific data, including session history, skill level, physiological metrics, hardware setup, and training objectives, which may be stored in or retrieved by the Driver Network.

Dynamic Programming: algorithmic technique used to break down the track into small, manageable segments to calculate the most efficient driving path.

Event Detection: real-time evaluation system that flags abnormal or critical events (e.g., wheel lock-up, veering off-track) that may require immediate feedback or note in the post-session analysis.

Feedback Loops: continuous process by which ADIS captures driver interactions, session performance outcomes, and user-generated responses to refine future coaching and recommendations; these loops occur at multiple stages—pre-session planning, real-time adjustment, and post-session review.

Feedback Loop Integration Protocol (FLIP): also referred to as the Closed-Loop Feedback (CLF) Microcontroller, this protocol manages the bidirectional data exchange between the system and the Driver across session phases. It ensures that session outcomes and Driver input (e.g., ratings, behaviors, reactions) are used to inform and update coaching parameters within the system in real-time or post-session.

Historical Information: stored data from previous sessions used to personalize future recommendations, update benchmarks, and inform reinforcement learning models.

Learning Models: general term for supervised or unsupervised ML models within ADIS that analyze performance trends. For example, the Core Engine's model personalizes insights to each Driver, while the OMS model refines general learning patterns across all networked data.

Learning Objective/Driver Objective: user-defined or system-recommended goal (e.g., improve lap time, braking consistency) that helps to shape the structure of feedback and coaching during a session. ADIS may handle multiple concurrent objectives in parallel evaluation. Real-time feedback prioritizes safety-related Objectives first, with other Objective priorities defined in the OMS.

Motorist Information Assistant (MIA): interactive AI-driven coach within ADIS that delivers tailored insights, voice prompts, and performance support to Drivers across all session phases.

Network Standardized Data: static or semi-static metrics used in benchmark calculations—e.g., global Driver averages, Track geometry, or past optimal performance, and may be based on the cumulative result of real-life and/or simulated data.

Network Variable Data: dynamic data affecting real-time performance—e.g., temperature, humidity, traffic, tire wear, or physiological metrics that are a factor in real-time and predictive calculations.

Objective-Based Feedback Prioritization: decision-making system that ranks and filters feedback cues according to the Driver's selected goals (e.g., braking mastery vs. lap time reduction). It may suppress unrelated coaching and emphasizes context-aligned guidance.

Optimal Racing Line: theoretical best-case driving path through a track, often based on idealized inputs, and may be used as the baseline for session evaluation.

Operator: person or team or other authorized user helping to manage a track infrastructure and ADIS programming via the OMS, responsible for setting operational goals, permissions, and standards.

Operator Control Layer: abstraction layer within the Operator Management System (OMS) through which Track Operators input parameters like safety thresholds, performance goals, and feedback filtering rules. This layer governs how operational standards influence system logic and Driver coaching.

Operator Management System (OMS): operator-controlled interface within ADIS that manages standardized data, sets Track-wide objectives, and monitors system-wide performance.

Persistent Context: data that carries over between sessions to inform future recommendations or comparisons.

Persistent Context Engine: subsystem within ADIS that maintains cross-session memory for each Driver, including unresolved objectives, feedback history, environmental adjustments, and benchmarking deltas. It may help to ensure recommendations evolve over time and reflect long-term Driver development patterns.

Personalized Benchmark: benchmark dynamically generated for a specific Driver based on their historical data, vehicle, objectives, and current conditions.

Post-Session: phase following a live session where ADIS processes, scores, and delivers detailed performance evaluations and training recommendations.

Post-Session Review: presentation of session insights, including segment analysis, skill scoring, optimal line comparison, and driver improvement suggestions.

Pre-Session: phase before the track session where the system loads driver data, validates hardware, sets performance baselines, and prepares recommendations.

Product Recommendation Engine: coaching subsystem that links performance deficits to curated hardware or software upgrades (e.g., tire compounds, telemetry devices, training programs). Recommendations may be driven by detected patterns in skill execution or session outcomes.

Reinforcement-Driven Personalization Loop: system behavior modification mechanism that uses historical performance outcomes, user feedback, and behavioral metrics to adapt future feedback and coaching instructions. It may help to enhance personalization by reinforcing successful strategies and penalizing ineffective ones.

Reinforcement Learning: AI-driven learning strategy where MIA and the Core Engine adapt over time by rewarding successful coaching outcomes and penalizing ineffective ones.

Reinforcement Learning Loop (RLL): machine learning submodule within the Core Engine and/or MIA that iteratively improves coaching accuracy through trial-and-error reinforcement. It may evaluate the outcome of feedback and updates internal policies to optimize for driver improvement and engagement.

Session: a discrete event on a track or roadway during which a driver engages ADIS to collect data, receive feedback, and work toward defined objectives.

Session Context: total set of inputs for a given session (e.g., driver profile, objectives, vehicle setup, track conditions, etc.).

Session Report: summary report delivered after each session that includes scores, event flags, improvement opportunities, and suggested next steps.

Session Visualization Engine: module that generates replays and visual representations of session data, including overlays of input data, racing line comparisons, and progress charts.

Segment-Aware Analysis: process where performance data is broken down by predefined Track segments (e.g., turn-in, apex, exit). This allows for fine-grained evaluation of Driver behavior and localized coaching recommendations based on zone-specific benchmarks.

Simulated Annealing and Genetic Algorithms: advanced optimization techniques used to simulate multiple lap paths, iteratively refining the racing line to achieve ideal performance outcomes.

Skill Execution: intentional driver behavior assessed during session review—e.g., steering input, braking precision, throttle modulation—measured against objectives.

Skill Execution Model: A predictive and comparative model used to assess how well a Driver executes specific driving inputs (e.g., braking, throttle, steering) relative to optimal patterns. It powers per-segment scoring, error detection, and the synthesis of actionable feedback.

Track: close-course racing circuit, whose properties (geometry, segments, surface) are digitally mapped and monitored within a track network.

Track Segments: defined zones of a track (e.g., corners, straights, braking zones) used for segment-level performance analysis and skill benchmarking.

Variable Networks: major data ecosystems feeding into ADIS (e.g., Driver Network, Vehicle Network, Environmental Network, and Track Network).

Vehicle: any logically relevant vehicle platform used during a session, whose telemetry and configuration data feed into performance modeling and recommendations.

Vehicle Data: specifications and real-time performance data including engine behavior, tire grip, brake temps, and accessory setup—all used in session evaluation. This data is loaded into the Driver Profile by the Driver and technical inspection teams.

### Example Driver Objectives

In ADIS, each session may be guided by one or more driver-selected objectives that help to define the system's focus for coaching, feedback, and analysis. These objectives may be evaluated in real-time and post-session using personalized benchmarks based on the vehicle, track, environmental conditions, and the driver's historical performance. Because every track is innately unique and each vehicle responds differently based on configuration, upgrades, and ambient driving conditions, ADIS may dynamically adapt performance expectations based on the session context. The selected objective informs what feedback may need to be prioritized, thus ensuring clarity and progression without overwhelming the Driver. Below are examples of supported Objectives that may be selected by the Driver or recommended by the system based on Curriculum alignment:

### Core Skill Objectives

1. Braking Mastery: improve braking precision by focusing on ideal deceleration points, threshold braking control, and lock-up avoidance across segment types.
2. Cornering Technique: Refine line selection, turn-in timing, and corner exit stability for maximum grip and minimal time loss through turns.
3. Throttle Control: optimize acceleration technique to reduce traction loss and improve drive out of corners without instability or overcorrection.
4. Weight Transfer Management: enhance control during directional changes by improving the balance and grip response of the Vehicle under braking, turning, and acceleration loads.
5. Segment Focus: target specific Track segments (e.g., complex corner sequences or heavy braking zones) for focused practice and deeper micro-analysis.
6. Full Circuit Optimization: improve overall lap performance by combining multiple skills to approach or exceed the calculated or average optimal racing line.

### General and Development Objectives

1. Practice Laps (Data Gathering): Drive without directed instruction; useful for warm-up, data accumulation, or hardware validation. Feedback is minimal and observational.
2. Physiological Performance: Improve response to physical strain by monitoring fatigue, stress levels, and grip strength under high G-force scenarios. May include breathing technique and focus tracking.
3. Race Strategy & Adaptability: Simulate or respond to changing race conditions such as weather variation, tire degradation, or traffic management to build situational awareness and in-race decision-making.

Each objective may influence how MIA delivers coaching during a session and how performance is evaluated in the Post-Session Review. Drivers may track progress over time or focus on different objectives across sessions, with the Curriculum Engine ensuring skill development follows a structured and meaningful progression path.

### Data Integration and Analysis

Data Integration and Analysis may refer to the core process or processes by which ADIS ingests, unifies, and interprets multi-source data from all networks—Driver, Vehicle, Environmental, and Track—into a normalized, analyzable format used to power real-time coaching, benchmarking, and post-session evaluation. The components involved are the Device Integration Hub (data ingestion), Core Engine (processing and analysis), Curriculum Engine (performance evaluation context), MIA (feedback delivery), and Permissions & Privacy Layer (data access governance). Some key functions for data integration and analysis may include:
1. Multi-Source Data Ingestion: the Device Integration Hub collects live and asynchronous data streams via APIs, SDKs, or direct sensor feeds. Supported data sources may include Vehicle telemetry (ECU, CAN, IMU, OBD-II), physiological telemetry and/or biometric wearables and driver inputs (e.g., heart rate, grip force), on-Track environmental sensors (temperature, grip, humidity), and Operator-defined variables from the OMS.
2. Data Normalization and Structuring: the Core Engine standardizes incoming data into a consistent internal schema. This includes features like time alignment across data streams, unit standardization (e.g., km/h→mph), and zone-based segmentation of performance data (e.g., turn-in, apex, exit).
3. Contextual Association: each data point is cross-referenced with session context (Driver, Objective, Track, Conditions) to ensure accurate comparisons and personalized relevance. For example, tire grip data may be evaluated in relation to humidity and Track temperature; Brake pressure may be analyzed by segment, Vehicle weight, and objective priority.
4. Real-Time Processing: during sessions, integrated data is streamed into the Core Engine for live Skill Execution evaluation, Event Detection (e.g., understeer, inconsistent throttle), and dynamic coaching recommendations via MIA.
5. Post-Session Analysis and Scoring: once the session ends, ADIS compiles cleaned and structured data into performance breakdowns by segment and input, benchmark comparisons (Optimal, Personalized, Historical), and adaptive updates to the Learning Models.

### Alternative Modes of Operation

While the primary implementation of ADIS focuses on real-time coaching for Drivers on closed-course Tracks, the system architecture supports multiple alternative modes of operation that expand its utility and deployment flexibility. These may include:
1. Simulated Environment Mode: ADIS may operate in conjunction with racing simulators, allowing Drivers to engage in virtual sessions using simulated telemetry, vehicle models, and track data. Feedback is generated using the same Learning Models, enabling skill development in off-track environments with hardware-in-the-loop or software-only configurations.
2. Offline Post-Processing Mode: in environments with limited connectivity or when real-time feedback is disabled (e.g., by option of Driver), ADIS can operate in a record-only mode. All session data is logged and subsequently analyzed during the Post-Session phase, delivering insights and recommendations without in-session coaching interruptions.
3. Operator-Controlled Group Mode: ADIS can be configured by an Operator to support synchronized sessions across multiple Drivers (e.g., in a training academy setting). The OMS assigns uniform objectives and benchmarking criteria, allowing coaches or Operators to compare session data across users and issue centralized recommendations.
4. Minimal Hardware Mode: in environments with restricted access to telemetry, biometric, or environmental sensors, for example, ADIS may operate in a degraded mode using only basic Vehicle telemetry and Driver input. While full feedback fidelity is reduced, the system continues to deliver benchmark-aligned coaching when possible, using available data sources.
5. Spectator Insight Mode (Read-Only): with appropriate permissions, ADIS can provide passive data visualization (e.g., via kiosks, spectator apps, or broadcast overlays) without disclosing sensitive personal telemetry. This mode enhances audience engagement while preserving Driver privacy and system integrity.

### System Innovation

The ADIS platform introduces a number of innovative features that distinguish it from existing designs in the fields of motorsport telemetry, driver coaching, and vehicle feedback systems. These innovations span system architecture, data integration, personalization methods, and user role dynamics. The following represents some of the core points of innovation for at least some of the disclosed ADIS concepts:
1) Multi-Network Data Integration: a modular data integration framework configured to receive and synchronize data across four distinct sources: (1) a driver network comprising user-specific physiological telemetry and behavioral data, (2) a vehicle network capturing real-time telemetry and control input data, (3) an environmental network including weather and atmospheric variables, and (4) a track network that maps real-time and historical conditions of the racing surface and features. This integration enables dynamic and contextual coaching feedback.
2) Objective-Based Feedback Prioritization: a feedback prioritization system that tailors coaching prompts based on user-selected performance objectives, wherein feedback generation and sequencing are dynamically adjusted to emphasize skills most relevant to the driver's declared goal (e.g., braking consistency, lap time reduction).
3) Operator Management System (OMS): an operator-facing management interface integrated with the driver feedback system, allowing track administrators to define, modify, and enforce benchmark parameters, safety limits, and evaluation criteria, wherein Operator-defined data influences the performance scoring and coaching logic applied to individual drivers.
4) Segment-Level Analysis: a data segmentation method wherein each track session is divided into discrete spatial zones (e.g., turn-in, apex, exit), and performance is evaluated within each zone based on comparison with benchmarked data, resulting in zone-specific feedback and targeted training recommendations.
5) Adaptive Coaching Lifecycle Engine: an adaptive feedback refinement model wherein the system modifies future feedback generation based on historical driver performance, post-session survey responses, and learning progression trends, using reinforcement learning to optimize future coaching outputs.
6) Curriculum-Aligned Skill Development Engine: a structured curriculum engine that maps discrete driving behaviors to long-term development milestones, enabling the system to evaluate session performance not only against momentary objectives, but also in the context of an overarching skill advancement path.
7) Permissions & Privacy Layer for Data Control: a configurable permissions framework that allows drivers to control the collection, usage, and visibility of session data, including telemetry, biometrics, and performance reports, with controls over data sharing with Operators, third parties, or anonymized benchmarking pools.
8) Persistent Session Context Across Use: a data persistence mechanism that retains and reuses contextual session data across multiple driving events, including historical feedback relevance, unresolved learning objectives, and prior session conditions, enabling longitudinal adaptation of feedback and recommendations.
9) Hardware-Agnostic Device Integration Hub: a hardware interface subsystem designed to support telemetry, biometric, and environmental data input from a wide variety of third-party or proprietary sources via API or SDK connections, allowing the system to operate independently of specific hardware vendors.
10) Dual Stakeholder System Design: a multi-role system architecture that simultaneously serves two independent users-drivers and track operators-via dedicated subsystems (MIA/Core Engine and OMS/Curriculum Engine, respectively), wherein each user's controls influence, but do not override the other's operational experience or data flow.
11) Session Context Memory for Dynamic Benchmark Evolution: a memory retention system configured to store session-specific metadata, including driver state, vehicle configuration, environmental conditions, and feedback history, used to dynamically adjust performance benchmarks across time and context without requiring static thresholds.
12) Data-Driven Product Recommendation Engine: a coaching subsystem configured to correlate skill deficiencies with targeted hardware or training interventions, enabling real-time product recommendations informed by analytical performance gaps.
13) Role-Specific Interface Modularity: a multi-user interface architecture including modular views for drivers, operators, and other admins (e.g., vehicle technology staff, operations admins, race control managers), each tailored to access permissions, performance data relevance, and operational control scopes.
14) Mixed-Modal Feedback Channeling: a feedback delivery system configured to determine optimal delivery modality (audio, visual, haptic, or augmented reality) based on situational awareness, urgency, and driver sensory availability.
15) Post-Session Visualization with Overlaid Skill Inputs: a visual feedback tool that overlays skill-specific input metrics (e.g., pedal pressure, steering modulation) onto trajectory and telemetry maps, enabling cause-effect linkage in post-session reviews.
16) Track Condition Drift Compensation: a track monitoring subsystem configured to detect and adjust for environmental degradation (e.g., rubber buildup, wet patches), ensuring driver evaluation is not misattributed due to variable conditions.
17) Objective Conflict Detection & Balancing: an objective arbitration engine that detects performance trade-offs between selected objectives and reprioritizes feedback delivery based on curriculum alignment, safety thresholds, or operator-defined policies.
18) Objective-Aligned Feedback Filtering Algorithm: a method for contextual feedback filtering comprising: receiving a selected driver objective; evaluating incoming telemetry and behavioral data; and dynamically suppressing or prioritizing feedback based on relevance to the objective's performance criteria.
19) Multi-Network Context Fusion Engine: a method of session context construction wherein a machine learning system assembles a weighted data object from a driver network, vehicle network, environmental network, and track network; and dynamically adjusts performance benchmarks based on relative network priority and recency of data updates.
20) Reinforcement Feedback Tuning via Driver Interaction: a system wherein machine-generated coaching instructions are iteratively refined using reinforcement feedback signals derived from user interactions, session outcomes, and behavioral compliance with prior recommendations.
21) Curriculum-Based Model Switching: a method of adaptive model selection wherein machine learning models are switched or blended based on a user's curriculum progression state, the session type, and a selected objective.
22) Segment-Aware Skill Decomposition Model: a driver analysis system comprising a machine learning model trained to isolate performance components within segmented driving zones, wherein each segment's skill execution is scored independently and synthesized into macro-level driver coaching statements.
23) Predictive Benchmark Adjustment Model: a system for predictive benchmark calibration using aggregate data trends across users, vehicles, and conditions to continuously update optimal performance targets based on observed shifts in capability under similar session contexts.
24) Real-Time Feedback Decision Engine: a context-aware coaching engine comprising a decision model configured to evaluate telemetry, biometrics, and session phase to select optimal timing and modality for feedback delivery.
25) Hybrid Model Framework for Explainable Feedback: a hybrid machine learning and rule-based driver support system configured to generate performance feedback paired with causal justification derived from explainable model outputs and session context.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, including those examples provided herein, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating an integrated driver feedback system for a driver of a motor vehicle on a closed-course track, the method comprising:
retrieving, via a system controller of the integrated driver feedback system, a respective driver profile specific to the driver;
determining, via the system controller using the driver profile, a respective set of baseline driving goals and driving session parameters specific to the driver;
receiving, via the system controller from a system memory device, track topography data specific to the closed-course track;
collecting, via the system controller from a network of vehicle sensors and driver sensors while the motor vehicle is driven on the closed-course track, sensor data indicative of real-time vehicle telemetry data of the motor vehicle and real-time driver physiological telemetry data of the driver;
generating, via the system controller using a trained and supervised machine learning (ML) model, a set of individualized feedback instructions specific to the driver based on the set of baseline driving goals and driving session parameters specific to the driver, the track topography data, the real-time vehicle telemetry data, and the real-time driver physiological telemetry data; and
commanding, via the system controller while the motor vehicle is driven on the closed-course track, a resident vehicle subsystem of the motor vehicle to execute a predefined vehicle operation based on the set of individualized feedback instructions specific to the driver.

2. The method of claim 1, further comprising collecting, via the system controller from a network of track sensors, sensor data indicative of real-time track surface conditions data of the track, wherein generating the individualized feedback instructions is further based on the real-time track surface conditions data.

3. The method of claim 2, further comprising collecting, via the system controller from a network of environment sensors, sensor data indicative of real-time ambient driving conditions of the track, wherein generating the individualized feedback instructions is further based on the real-time ambient driving conditions of the track.

4. The method of claim 3, further comprising modifying, via the system controller prior to the motor vehicle being driven on the closed-course track, one or more benchmark settings in the driving session parameters specific to the driver to offset select conditions in the real-time track surface conditions data and/or the real-time ambient driving conditions of the track.

5. The method of claim 1, further comprising receiving, via the system controller from a driver graphical user interface (GUI), a driver-selected session type including a driver-selected objective, wherein generating the individualized feedback instructions is further based on the driver-selected objective of the driver-selected session type.

6. The method of claim 5, further comprising:
generating, via the system controller, a set of pre-session feedback instructions specific to the driver based on the driver-selected session type; and
commanding, via the system controller, the driver GUI to display the pre-session feedback instructions to the driver.

7. The method of claim 6, wherein the set of pre-session feedback instructions include a recommended hardware change and/or a recommended vehicle modification determined to improve driving performance of the driver based on the driver-selected session type and the baseline driving goals and driving session parameters specific to the driver.

8. The method of claim 1, further comprising:
generating, via the system controller, a set of post-session feedback instructions specific to the driver based on the set of baseline driving goals and driving session parameters, the real-time vehicle telemetry data, and the real-time driver physiological telemetry data; and
commanding, via the system controller, a driver graphical user interface (GUI) to display the post-session feedback instructions to the driver.

9. The method of claim 1, further comprising:
segmenting the closed-course track into a series of interconnected track segments;
tracking a real-time location of the motor vehicle on the closed-course track;
determining a respective track segment topography and/or a real-time track surface condition of a track segment in the series of interconnected track segments forward of the real-time location of the motor vehicle on the closed-course track; and
commanding the resident vehicle subsystem to output an alert to the driver based on the respective track segment topography and/or the real-time track surface condition of the track segment forward of the real-time location of the motor vehicle.

10. The method of claim 1, wherein generating the set of individualized feedback instructions specific to the driver includes segmenting the real-time vehicle telemetry data and the real-time driver physiological telemetry data collected while the motor vehicle is driving into data subsets each specific to a respective zone of the closed-course track, and performing a comparative analysis of each of the data subset with a respective driver input model associated with the respective zone of the closed-course track.

11. The method of claim 1, wherein the resident vehicle subsystem includes an audio system and/or a haptic system within a passenger cabin of the motor vehicle, and wherein the predefined vehicle operation includes the audio system outputting an audio cue and/or the haptic system outputting a tactile cue indicative of one of the individualized feedback instructions.

12. The method of claim 1, wherein the resident vehicle subsystem includes an augmented reality (AR) headset within a passenger cabin of the motor vehicle, and wherein the predefined vehicle operation includes the AR headset displaying one of the individualized feedback instructions within a line of sight of the driver.

13. The method of claim 1, wherein the resident vehicle subsystem includes a head-up display (HUD) device within a passenger cabin of the motor vehicle, and wherein the predefined vehicle operation includes the HUD device displaying one of the individualized feedback instructions within a line of sight of the driver.

14. A non-transient, computer-readable medium storing instructions executable by a system controller of an integrated driver feedback system for optimizing driving performance of a driver of a motor vehicle on a closed-course track, the instructions, when executed, causing the system controller to perform operations comprising:
retrieving a respective driver profile specific to the driver;
determining, using the driver profile, a respective set of baseline driving goals and driving session parameters specific to the driver;
receiving, from a system memory device, track topography data specific to the closed-course track;
collecting, from a network of vehicle sensors and driver sensors while the motor vehicle is driven by the driver on the closed-course track, sensor data indicative of real-time vehicle telemetry data of the motor vehicle and real-time driver physiological telemetry data of the driver;
generating, using a trained and supervised machine learning (ML) model, a set of individualized feedback instructions specific to the driver based on the set of baseline driving goals and driving session parameters specific to the driver, the track topography data, the real-time vehicle telemetry data, and the real-time driver physiological telemetry data; and
commanding a resident vehicle subsystem of the motor vehicle to execute a predefined vehicle operation based on the set of individualized feedback instructions specific to the driver while the motor vehicle is driven by the driver on the closed-course track.

15. A driver feedback system for a driver of a motor vehicle on a closed-course track, the driver feedback system comprising:
a system memory device configured to store system data;
a network of track sensors on the closed-course track;
a data communications interface operatively connected to the system memory device, the network of track sensors, and a network of vehicle sensors and driver sensors; and
a system controller programmed to:
retrieve a respective driver profile specific to the driver;
determine, using the driver profile, a respective set of baseline driving goals and driving session parameters specific to the driver;
receive, from the system memory device, track topography data specific to the closed-course track;
collect, from the network of vehicle sensors and driver sensors while the motor vehicle is driven by the driver on the closed-course track, sensor data indicative of real-time vehicle telemetry data of the motor vehicle and real-time driver physiological telemetry data of the driver;
generate, using a trained and supervised machine learning (ML) model, a set of individualized feedback instructions specific to the driver based on the set of baseline driving goals and driving session parameters specific to the driver, the track topography data, the real-time vehicle telemetry data, and the real-time driver physiological telemetry data; and
command a resident vehicle subsystem of the motor vehicle to execute a predefined vehicle operation based on the set of individualized feedback instructions specific to the driver while the motor vehicle is driven by the driver on the closed-course track.

16. The driver feedback system of claim 15, wherein the system controller is further programmed to collect, from the network of track sensors, sensor data indicative of real-time track surface conditions data of the track, wherein generating the individualized feedback instructions is further based on the real-time track surface conditions data.

17. The driver feedback system of claim 16, wherein the system controller is further programmed to collect, from a network of environment sensors, sensor data indicative of real-time ambient driving conditions of the track, wherein generating the individualized feedback instructions is further based on the real-time ambient driving conditions of the track.

18. The driver feedback system of claim 17, wherein the system controller is further programmed to modify one or more benchmark settings in the driving session parameters specific to the driver to offset select conditions in the real-time track surface conditions data and/or the real-time ambient driving conditions of the track.

19. The driver feedback system of claim 15, wherein the system controller is further programmed to receive, from a driver graphical user interface (GUI), a driver-selected session type including a driver-selected objective, wherein generating the individualized feedback instructions is further based on the driver-selected objective of the driver-selected session type.

20. The driver feedback system of claim 15, wherein the system controller is further programmed to:
generate a set of post-session feedback instructions specific to the driver based on the set of baseline driving goals and driving session parameters, the real-time vehicle telemetry data, and the real-time driver physiological telemetry data; and
command a driver graphical user interface (GUI) to display the post-session feedback instructions to the driver.
